(19) United States
(12) Patent Application Publication
(10) Pub. No.: US 2003/0181273 A1
(43) Pub. Date: Sep. 25, 2003

(54) Wear resistant tensioner

(76) Inventors: Takerou Nakagawa, Osaka (JP); Shigeo Tamura, Osaka (JP)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/354,685

(22) Filed: Jan. 30, 2003

(30) Foreign Application Priority Data
Mar. 19, 2002 (JP) 76690/2002

(51) Int. Cl. F16H 7/08; F16H 7/22

(52) U.S. Cl. 474/101; 474/109

(57) ABSTRACT

A tensioner is formed with components having improved wear resistance. At least one component of the tensioner is covered with a diamond-like amorphous carbon coating (DLC). The coating is applied to the tensioner without causing hydrogen brittleness in metallic members. In addition, the coating may be formed on tensioner components formed with resin. In one embodiment of the invention, a metal element is dispersed into the diamond-like amorphous carbon coating.

### FIELD OF THE INVENTION

The present invention relates to a tensioner for imparting an appropriate tension to a chain, cable or belt.

### BACKGROUND OF THE INVENTION

A tensioner is used in a transmission device using a chain, cable or a belt, such as a timing chain on an engine. The tensioner applies an appropriate tension to the chain to limit the development of slack in the chain. In the tensioner, a plunger is slidably disposed in a plunger receiving hole formed in the tensioner housing. The plunger is movable forward and backward in the plunger receiving hole and biased by a plunger spring in the plunger receiving hole. The plunger imparts an appropriate tension to a chain or belt through a tensioner lever.

When the plunger moves back and forth in such tensioners, sections of the plunger, tensioner lever, and inner wall of the plunger receiving hole slide against one another, gradually causing wear. In the prior art, to improve wear resistance on these surfaces, the surfaces are subjected to lead plating or nickel plating. Alternatively, the surfaces are coated with a hardened layer of metal carbide or metal nitride.

When a tensioner component is subjected to lead plating or nickel plating, hydrogen absorption can occur, which can adversely affect the structure and cause hydrogen brittleness in the formation of the plated film, greatly reducing mechanical strength of the part. Further, the formation of plated films on tensioner levers comprising a resin has not been successful.

Hardened layers containing metal nitride or metal carbide or the like has excellent wear resistance as compared with a lead plated layer or a nickel plated layer. However, metal nitride and metal carbide layers do not exhibit the amount of wear resistance required to meet the demands of newer transmission devices which run at higher speeds and higher loadings. Therefore, a further improvement of wear resistance has been required.

### SUMMARY OF THE INVENTION

Accordingly, the object of the present invention is to provide a tensioner with improved wear resistance.

Another object of the present invention is to provide a tensioner with metallic components that are not prone to hydrogen brittleness.

Another object of the present invention is to provide wear resistance on members formed of resin in the same way that wear resistance is applied to members containing other materials.

To attain said objects, a wear resistant tensioner is provided having a plurality of components. A surface on at least one of the components comprises a diamond-like amorphous carbon coating. In one embodiment of the invention, a metal element is dispersed in the diamond-like amorphous carbon coating.

The tensioners of the present invention are tensioners used for applying an appropriate tension to a chain, cable or belt, such as a tensioner used for a timing chain of an engine, a tensioner used for a conveyor chain for distribution, or a tensioner used for an elevator chain. The tensioners of the present invention may be used in any chain, cable or belt application where tension adjustment is desired, and use of the invention is not limited to the uses explicitly described above.

The diamond-like amorphous carbon (DLC) refers to a carbon coating film having properties similar to diamond. The DLC carbon coating forms a hard thin film using materials not previously applied in a coating of this kind. Moreover, no DLC has been previously considered as a coating film for a tensioner. It has been found that when a diamond-like amorphous carbon is used as a coating film material for a tensioner, the tensioner exhibits excellent wear resistance and shock resistance.

The present invention, having the above-described configuration, exhibits the following characteristics.

Since a surface of at least one component forming the tensioner is subjected to a diamond-like amorphous carbon coating, hydrogen brittleness is avoided and mechanical strength is improved. Further, the coefficient of wear on coated parts is reduced and wear resistance is enhanced. Moreover, the generation of noise and foreign sound by tensioner parts is suppressed.

In one embodiment of the present invention, a metallic element is dispersed in said diamond-like amorphous carbon coating. Accordingly, inner stress is reduced in the coating, and the adhesion between the coating and the tensioner component is improved. Further, the coating exhibits increased toughness and durability and improved performance under plastic deformation.

### BRIEF DESCRIPTION OF THE DRAWINGS

The foregoing summary as well as the following description will be better understood when read in conjunction with the figures in which:

FIG. 1 is a plan view showing a wear resistant tensioner in accordance with the present invention.

FIG. 2 is a graph showing Vickers hardness of a diamond-like amorphous carbon coating used in the present invention.

FIG. 3 is a table summarizing physical properties of the diamond-like amorphous carbon coatings used in the present invention.

### DETAILED DESCRIPTION OF THE INVENTION

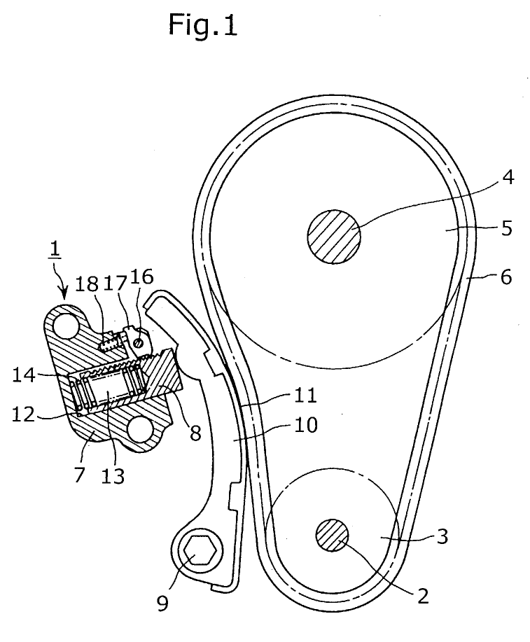

A first embodiment of the present invention will be described with reference to FIG. 1. FIG. 1 shows a tensioner 1 used in a timing chain of an engine. In this tensioner 1, a plunger 8 is movable forward and backward in a plunger receiving hole 12 formed in a tensioner housing 7. The plunger 8 is biased by a spring 14 in the plunger receiving hole 12. The plunger 8 imparts an appropriate tension to the timing chain 6 through a tensioner lever 10.

When the plunger 8 moves back and forth, the front end of the plunger engages the tensioner lever 10, and the sides of the plunger engage the inner walls of the plunger receiving hole 12. Over time, the engaging surfaces gradually wear. In FIG. 1, the tensioner lever 10 has a shoe 11 that engages the timing chain 6. The engagement between the shoe 11 and chain 6 creates significant friction and shear stress which gradually wear down the shoe surface. To increase wear resistance, a diamond-like amorphous carbon coating (DLC) is applied to surfaces that contact other surfaces.

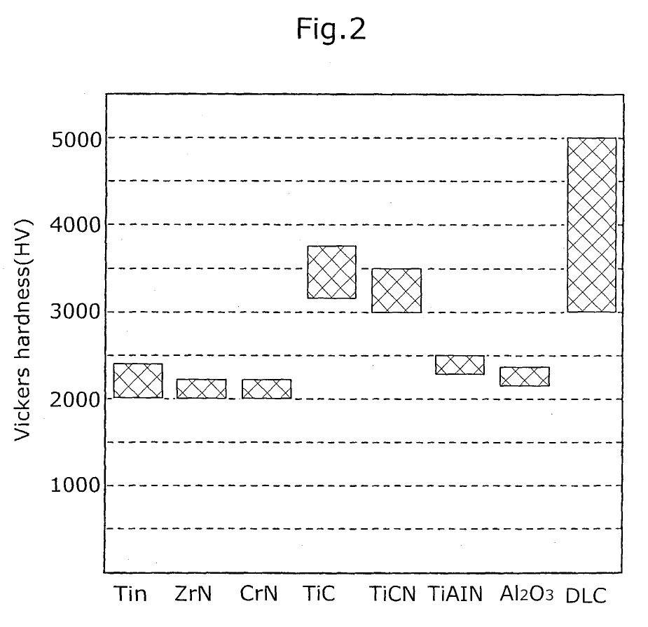

FIG. 2 shows the Vickers hardness of the diamond-like amorphous carbon coating films used in the present invention, together with hardness values for coatings formed with metal nitrides and metal carbides, which are commonly used in conventional chain coating films. As apparent from FIG. 2, the diamond-like amorphous carbon coating films have a significantly higher Vickers hardness as compared with hardness values of the metal nitride and the metal carbide coatings.

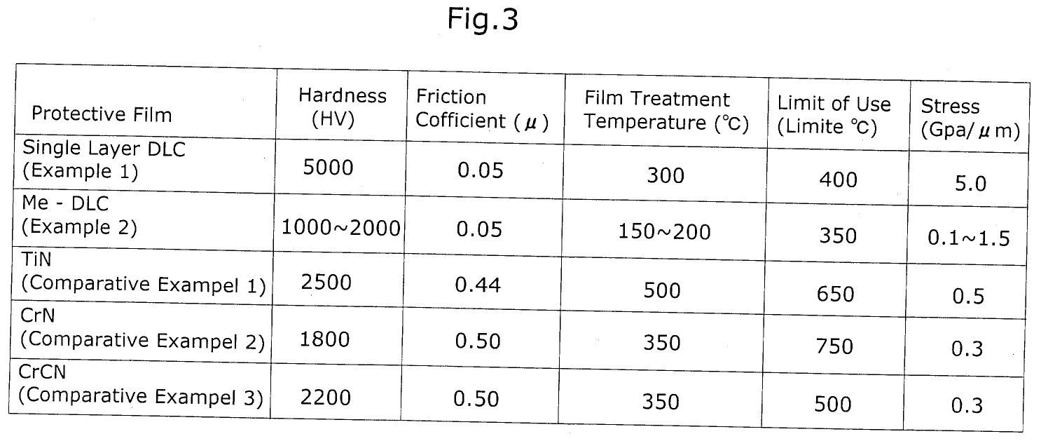

FIG. 3 summarizes the physical properties of the diamond-like amorphous carbon coating (DLC) used in the first embodiment of the present invention and a coating material containing tungsten dispersed in a diamond-like amorphous carbon coating (Me-DLC), as used in a second embodiment of the present invention. FIG. 3 also summarizes physical properties of coatings formed with metal nitrides. Although the hardness of the tungsten-dispersed DLC film used in the second embodiment is less than that of DLC film used in the first embodiment, the hardness of the film used in the second embodiment is comparable to the hardness provided by the metal nitrides. However, the friction coefficient for the tungsten-dispersed DLC film of the second embodiment, and for the DLC film of the first embodiment, are extremely small, having coefficients that are approximately one tenth of the friction coefficients associated with metal nitrides. Further, the tungsten-dispersed DLC film of the second embodiment has a much lower inner stress than that of DLC film of the first embodiment and is not prone to chipping. Thus, the tungsten-dispersed DLC film of the second embodiment is an excellent film material for use on a tensioner lever, particularly tensioners that are subjected to large surface pressure and shock. The DLC film of the second embodiment is also an excellent material for use on a timing chain tensioner of an engine used in environments subjected to significant changes in temperature. Although tungsten is used as a metal element dispersed in a diamond-like amorphous carbon coating in the second embodiment, another metal element such as chromium, titanium or the like can also be used.

In the present invention, as a process of forming a diamond-like amorphous carbon coating (DLC), a known DLC film forming process can be used. Concrete processes of forming the DLC film include a high-frequency plasma CVD process using a hydrocarbon gas as a reactive gas, an ion-beam vapor-deposition process in which ions of well-controlled kinetic energy are irradiated onto a substrate in a high vacuum atmosphere, and a vacuum arc process or sputtering process in which fine carbon particles are generated from solid carbon by vacuum arc or sputtering. As described above, the diamond-like amorphous carbon coating in the present invention is formed by dry processes. Accordingly, hydrogen is not absorbed into the metal structure of tensioner parts during the film forming steps, and hydrogen brittleness is prevented. As a result, mechanical strength is not reduced by the film forming process. Further, since the dry processes do not use a substrate as an electrode, unlike electrolytic plating, a film can be formed on not only a surface of metal but also a surface of resin. Accordingly, a DLC film can be formed on the surface of a tensioner shoe containing resin using the same film-forming technique.

The wear resistant tensioner according to the present invention having the above-described device configuration exhibits the following characteristics. Since a surface of at least one component forming the tensioner is subjected to a diamond-like amorphous carbon coating, the reduction of mechanical strength due to hydrogen brittleness is avoided and mechanical strength is improved for a long period of time. Further, the coefficient of wear is reduced and wear resistance is enhanced. Moreover, the generation of noise and foreign sound is suppressed.

Where a metal element is dispersed in said diamond-like amorphous carbon coating, inner stress in the coating is reduced, and adhesion between the coating and the tensioner component is improved. The coating containing dispersed metal also shows increased toughness and improved performance under plastic deformation. Therefore, even in an environment in which large surface pressure or impact is applied, or an environment in which a temperature change is large, wear resistance of the tensioner can be maintained for a long period of time.

1. A wear resistant tensioner having a plurality of components, said tensioner wherein a surface of at least one of the components comprises a diamond-like amorphous carbon coating.

2. The wear resistant tensioner of claim 1, wherein a metal element is dispersed in said diamond-like amorphous carbon coating.
